(19) United States
(12) Patent Application Publication
(10) Pub. No.: US 2006/0165102 A1
(43) Pub. Date: Jul. 27, 2006

(54) Individual update or reorganisation of message and dialogue services specific to service providers

(76) Inventors: Mathias Franz, Berlin (DE); Detlev Freund, Berlin (DE); Norbert Lobig, Darmstadt (DE); Johannes Schopf, Furstenfeldbruck (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/564,907

(22) PCT Filed: Jul. 15, 2004
(86) PCT No.: PCT/EP04/51510

§ 371 Date: Jan. 17, 2006

(30) Foreign Application Priority Data
Jul. 18, 2003 (DE) 10332839.4

(51) Int. Cl. H04L 12/56

(52) U.S. Cl. 370/401; 370/352

(57) ABSTRACT

The invention permits service providers to self-configure message or dialogue services on an arrangement provided by an independent network operator. Said arrangement comprises a provider device, to which the service provider has access. Components or elements of messages or dialogues, altered or newly generated by service providers, stored in the provider device, are transmitted to one or more provision devices, where the above are available for information output devices for the processing of a new or changed message or dialogue service. According to the invention, an interface between service provider and network operator is achieved, which permits the service provider an efficient configuration of the services provided thereby and the use of resources provided by a network operator. As a result of the structure of the interface and by means of security measures undesired viewing or access to the resources of the network operator can be avoided.

### CROSS REFERENCE TO RELATED APPLICATION

This application is the US National Stage of International Application No. PCT/EP2004/051510, filed Jul. 15, 2004 and claims the benefit thereof. The International Application claims the benefits of German Patent applications No. 10332839.4 DE filed Jul. 18, 2003, both of the applications are incorporated by reference herein in their entirety.

### FIELD OF THE INVENTION

The invention relates to an arrangement for service-provider-triggerable provision of components for an information output or an interactive dialog and a method for providing components for newly created or changed information outputs or interactive dialogs by means of an arrangement comprising a supply device and at least one provision device.

### BACKGROUND OF THE INVENTION

In telecommunications and data transmission, an increasingly important role is being played by services characterized by automated information transmission or an automated user interaction. These include, for example, the conventional recorded message services, but also interactive services e.g. for banking or for configuring mailboxes for mobile telephones. In the course of the rapid evolution of the networks, services are also conceivable in which audio or video information can be called up interactively e.g. as part of a video-on-demand service. For an information output or interactive service of this kind, network functions must be provided which allow communication between service provider and service user. For this there are conventionally two models:

either a network operator provides one or more service providers with functions for performing the service or services which are located on suitable hardware, e.g. a switch or server device. For any change to a service, the service provider must then submit a change request to the network operator who then realizes or implements the change on his hardware.

A second approach is to relocate the entire recorded message or interactive service to an external, i.e. switch-independent, platform on the service provider's premises. The service provider then operates a hardware device on which he makes his services available to the service users. In this case the service provider only uses the functionality provided by the network operator to communicate or switch the information transmitted as part of a service.

The disadvantage of the first approach is that changing or reconfiguring services is a laborious process for the service provider. The second alternative has considerable cost implications for the service provider, namely procuring and maintaining dedicated hardware (e.g. an IVR server (Interactive Voice Response Servers)), which is only optimally utilized in exceptional cases.

### SUMMARY OF THE INVENTION

The object to the invention is to optimize interactive services or information output services so as to avoid the disadvantages of conventional methods.

This object is achieved by an arrangement according to the claims and a method according to the claims.

The invention is based on the following knowledge:

On the one hand, hardware for interactive or voice output services must be usable for a plurality of service providers in order to enable optimum utilization of the available resources. On the other hand, service providers must have as many options and as much freedom as possible in terms of configuring their services. Ideally the services must be directly modifiable or changeable, i.e. without the intervention of the network operators. According to the invention, suitable interfaces for this purpose are provided by an arrangement within the area of responsibility of the operator of the information output system or IVR system. This storage arrangement comprises a supply device for supplying elements or components for information outputs or interactive dialogs, and a provision device for providing elements or components for information outputs or interactive dialogs, said elements or components for information outputs or interactive dialogs being transmittable from the supply device to the provision device. Service providers have access to the supply device and can configure or modify the services they provide by means of new or changed elements or components for information outputs or interactive dialogs. Changed or new elements or components are then transferred to the provision device. The supply device and the provision device can be implemented on the same hardware. In a preferred embodiment, however, they are implemented on different hardware and a supply device supplies or serves a plurality of provision devices. In this case it is advisable to duplicate the supply device. In other words the arrangement according to the invention is subdivided into a Master Content Function, implemented by the supply device, and a Slave Content Function constituted by the provision device. Only on the former can external service providers make changes which are automatically transferred to the provision devices. The transfer or transmission of information output elements or components of information outputs or interactive dialogs takes place e.g. using the “Remote Shell rsh” or “Remote Copy rcp” command of the UNIX operating system. The components or elements transferred to the provision device are available to information output systems or interactive systems, e.g. IVR servers, which access the components or elements provided for performing services. It will hereinafter be assumed that an information output system or interactive system comprises an information output device by means of which information which is part of an information output or interactive dialog can be fed out to a service user. Said information output device can be e.g. an IVR server. The provision device can be disposed on the same hardware equipment as the information output functions or the information output device. For communication of the modified or new components and elements by the provision device to the information output device there are e.g. the following two options:

Implicit transmission e.g. by the caching function of a browser of the information output device. Depending on requirements and service provider it is determined how long the service definitions (recorded messages or interactions) retain their validity. The change is then implemented at the required time by the triggering of an update of the cache information, in the course of which the updated content is loaded.

Explicit transmission by means of a protocol between the provision device and the information output device. By means of said protocol, the change in the content of a recorded message or interactive dialog is signaled to tfie information output device, it being possible to transmit changed or new components or elements simultaneously. In a preferred embodiment, however, only the change is communicated. When executing the corresponding service, the information output device then accesses the components or elements held in the provision device.

Between service providers and the operator of the information output system, the invention defines an interface which ensures efficient resource utilization and flexibility for configuring the service. On the one hand, service providers can configure their services without intervention by the operator of the information output system, on the other hand the automatic distribution of the information output elements of the provision device ensures that the actual information output service or interactive dialog with the user fall fully within the area of responsibility of the operator of the information output system, i.e. ensuring a clear separation of the services provided. This increases the security of the system. Service providers cannot access provision devices directly, but can trigger or initiate changes or reconfiguration of their services by accessing the supply device. The structure or topology of the system provided by the network operator is not transparent for the service providers. Thus service providers cannot e.g. collect data relating to the network topology or network status contrary to the interest of the network operator. The option of using a large number of provision devices additionally allows high scalability at little additional expense for the operator of the information output system or interactive system and at no additional expense for service providers.

In addition to the elements or components for services offered by service providers, elements/components can also be stored in the supply device by the operator of the information output system or interactive system which are used, for example, for changed or replaced system messages.

According to another advantageous further development, one or more security measures are taken to avoid supply device access problems. Such measures could include:

A strict separation of the storage area on the supply device to which the various service users or the operator of the information output system/interactive system have access can be implemented e.g. by suitable setting of authorizations.

Access to the supply device or particular storage area thereof can be protected using passwords or authentication measures.

Access to the supply device can be additionally protected against impermissible data transmission with the aid of a firewall.

It is further advantageous to associate a charge with the modification or re-storing of elements or components for information output services or interactive services, the modification or re-storing e.g. triggering the creation of a charge ticket in a charging server, for example, to which the change is signaled.

It is conceivable both that a service provider logs in directly on the supply device in order to make changes there, and that modified elements/components are transmitted to the supply device where they possibly replace older versions of the corresponding element or component. In the latter case there can be provided, e.g. within the service provider's area of responsibility, a component configuration system—implemented on a PC, for example—which is used for modifying the services, and from which changed or new elements or components for information output services or interactive services are transferred to the supply device. Likewise the operator of the information output system or interactive system can have at his disposal a component configuration device in order thus to change recorded messages or interactive dialogs, e.g. system messages, assigned to him. The provision devices make available, for example, information output elements or components for information output devices which access a supply device for a service, e.g. an information output or interactive dialog. The provision device and the information output device can also be implemented in an integrated manner.

Information output elements or components can contain e.g. XML or VXML files (XML: Extensible Markup Language, VXML: Voice XML), WAV files (WAV: Wa-ve; the files encode audio information) or so-called grammars, i.e. control files for analyzing the voice input in the case of dialogs. Voice output control or the combining of voice outputs takes place e.g. by means of Voice XML files (VXML files). Here in general the terms information output element, element and component are used in such a way that they relate to all the data or files that are necessary for the combining and playback of information outputs or interactive dialogs, which means in particular that they may relate to content information, control information or formation rules for information outputs or interactive dialogs. For example, output elements can also contain, with the aid of a codex, precoded fragments (e.g. speech or video fragments) which are then combined to form an output. Precoding has the advantage of an efficiency gain, as the coding complexity during the execution of a service can be reduced.

The invention is applicable to various types of network including circuit-switched networks as well as packet-switched networks. Likewise both voice and video information can be output as part of the services.

### BRIEF DESCRIPTION OF THE DRAWINGS

The invention will now be explained in greater detail with reference to an example and the accompanying drawings in which:

FIG. 1: Schematically illustrates a system for generating and outputting information outputs or interactive dialogs which comprises an inventive arrangement, and

FIG. 2: Schematically illustrates physical components of a system for generating and outputting information outputs or interactive dialogs which comprises an inventive arrangement.

### DETAILED DESCRIPTION OF THE INVENTION

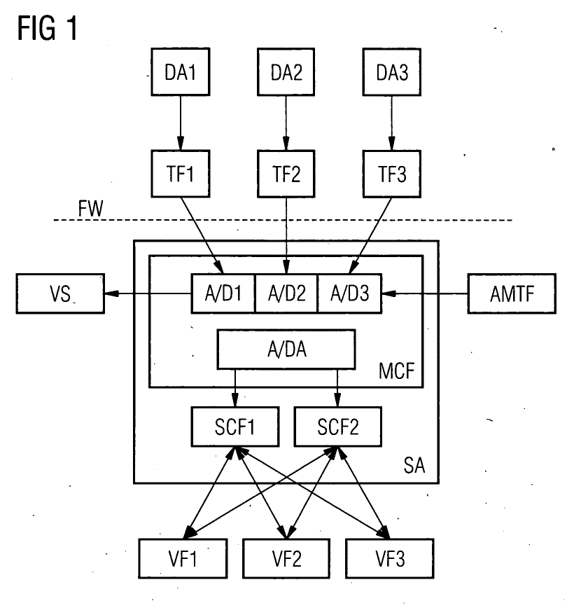

FIG. 1 schematically illustrates a system for generating or creating information outputs, e.g. voice outputs, or interactive dialogs which can be made available to service users. According to the invention, service providers DA1, DA2 and DA3 can access an inventive arrangement SA (storage arrangement) which is operated and administered by a network operator or an operator of an information output or interactive dialog system. The service providers DA1, DA2 and DA3 access the arrangement SA by means of configuration systems TF1, TF2 and TF3 (TF: Tooling Function) assigned to them for information outputs or interactive dialogs. Within the configuration system TF1, TA2 and TF3, components for new or changed information outputs or interactive dialogs can be created. These components are then transferred to the storage arrangement SA using e.g. the HTTP protocol and stored on a storage area A/D1, A/D2 or A/D3 for recorded messages A or interactive dialogs D assigned to the relevant service provider DA1, DA2 or DA3. The access of the service providers DA1, DA2 and DA3 is protected by the fact that authorizations exist only for the particular storage area A/D1, A/D2 or A/D3 assigned to him, and that a firewall FW is provided between the arrangement SA and the configuration systems TF1, TF2 and TF3 of the service providers DA1, DA2 or DA3. The operator of the storage arrangement SA himself has at his disposal a configuration system AMTF (Administration Master Tooling Function) from which he can store [lacuna] for system messages or interactive dialogs associated with the network operator from components for messages A or interactive dialogs D on a storage area A/DA (A/DA: messages A or interactive dialogs D of the network operator or administrator A). The storage arrangement SA itself is subdivided into two different functional parts, namely a supply device MCF (Master Content Function) containing the storage areas which the service providers DA1, DA2 and DA3 and the system operator access via the configuration system AMTF. The access of a service provider or the storing of one or more new or changed components for messages or interactive dialogs triggers or initiates two events: on the one hand the changed or new components are transferred to provision devices SCF1 and SCF2 (SCF: Slave Content Function) where they are available for information output devices, such as VF1, VF2 and VF3 (VF: Voice Function). On the other hand, the storing of new or changed components causes charging of this change to be set in train, which is implemented by means of a message sent to the charging server VS. In the same way as for the service providers, components stored by the system operator or network operator by means of the configuration system ATMF are automatically transmitted to the provision devices SCF1 and SCF2, charging generally being unnecessary, as the configuration system AMTF and arrangement SA belong to the same operator. The information output devices VF1 to VF3 use components stored in the provision devices SCF1 and SCF2 for handling the services, from which components the output required as part of the service or the required interactive dialog is composed.

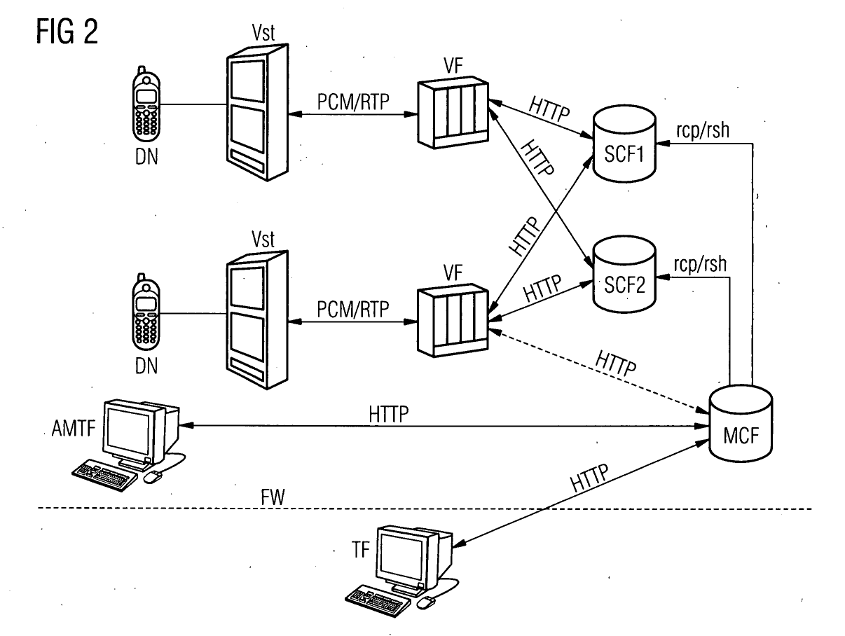

Although the storage arrangement SA forms a functional unit, in a preferred solution it is implemented by means of separate hardware elements. This preferred version is illustrated in FIG. 2. FIG. 2 shows the component configuration system TF of a service provider, as well as the component configuration system AMTF of the system operator from which new or changed components can be transmitted e.g. via an IP network to the supply device MCF by means of the HTTP protocol. Service provider access is again protected by firewall FW. Modified or new components are transmitted to the provision devices SCF1 and SCF2 by means of the Unix commands rcp (remote copy) or rsh (remote shell). In this version the supply devices MCF associated with the arrangement SA, as well as the provision devices SCF1 and SCF2 are implemented on various hardware platforms or servers. The provision devices SCF1 and SCF2 can be accessed by information output devices VF for handling a recorded message or interactive service. A recorded message or interactive service is controlled by a switch Vst, with recorded message or interactive services being possible both via circuit-switched networks using PCM (Pulse Code Modulation) and via packet-switched networks by means of the RTP protocol(RTP: Real Time Protocol) which was designed for real-time traffic handled via IP networks. Information fed out by the information output devices VF is finally transmitted using the switch Vst to a service user DN who is using a service offered by the service provider.

Examples of services that can be implemented by a service provider using the systems described in FIG. 1 or FIG. 2 are:

A service provider is a telecommunications provider wishing to draw the attention of callers on hold to his latest offers. The offer message is updated monthly.

Another service provider uses televoting to allow people to participate in his prize draw. In the recorded message for rejecting non-accepted participants, the caller's attention shall be drawn to new developments in the prize draw in order to make him/her call again. This message must be updated daily.

Both services can be implemented by leasing resources from the network operator or the operator of the inventive arrangement SA and interactive system VF.

The network operator himself also wants to be able to change his system messages. This generally happens somewhat rarely, e.g. in the case of a version change in switches Vst in his area of responsibility.

Each of the service providers receives the URL (Universal Resource Locator) for a Web GUI (GUI: Graphical User Interface) in which he can define the content of the corresponding recorded messages and interactive dialogs by text (in which case text-to-speech software is used) or WAV files (e.g. recorded on his PC or in a sound studio). He additionally specifies the time of updating. Then the relevant changes are checked for correctness on a so-called Master Resource Content Server (corresponding to the supply device MCF) and recorded (using Voice XML), and the required WAV files are loaded onto the server.

For this purpose each service provider is pre-assigned a directory (A/D1, A/D2 and A/D3 in FIG. 1) on the Master Resource Content Server MCF in which are located the recorded messages that can be changed by him. This directory is protected by username/password identification.

The corresponding recorded messages are diverted to the service provider's directory (A/D1, A/D2 or A/D3 in FIG. 1). For this purpose, the new description in the service provider's directory is referenced in a Voice XML file which is called up by default for the corresponding message.

The Voice XML file in the provider's directory is replaced by the new definition at the time of the change.

The changes made on the Master Resource Content Server MCF are replicated onto the Slave Resource Content Servers or provision devices (SCF1 or SCF2 in the Figures) by means of the UNIX commands rcp (remote copy; copying of data to another server) and rsh (remote shell; issuing system commands to another server). The number of these servers can be adapted to suit the performance required.

Simultaneously a charging ticket is created at the time of the change which records data such as the service provider's ID, the time of the change, etc. This enables the change as well as the different change intervals to be charged by the network operator.

Via an administration GUI (GUI: Graphical User Interface) the network operator is able to administer his own system messages. Here a complete record of new system messages can be displayed. It is possible for this change also not to be implemented until a particular time (e.g. low-traffic periods). The changes for the service providers are used by this tool, i.e. the administrations GUI or the configuration system AMTF of the operator, for the new definitions of the system messages.

The network operator can set up new IDs for the service providers on the Master Resource Content Server MCS. The messages are then assigned to these IDs, the tooling creating the appropriate directories and referencing this directory for the corresponding messages. (This reference is canceled again when the user is deleted.)

These changes also are replicated onto the Slave Resource Content—Servers.

Also the setting-up of these Slave Resource Content Servers themselves can be carried out with the GUI.

The change is notified to the Resource Voice Server (Voice Function VF1, VF2 and VF3 in FIG. 1, VF in FIG. 2), it being e.g. possible to influence the caching time of the message via the configuration of the Apache webserver by means of .htaccess file (this is part of the http protocol and is transmitted over it to the Resource Voice Server).

Via the administrations GUI, the network operator has the opportunity of also changing the caching time which he can set differently for the various service users. He can likewise define lower and upper bounds as well as a preset value within these bounds specifically for a service provider, so that the latter has the option of changing the preset possibly in a manner affecting charging within the specified interval.

In the case of the first example described above for a provider using the system according to the invention, a change interval of 24 hours can be selected. Only when the definition is one day old is a new definition retrieved from the information output device or the Resource Voice Server VF by the Slave Resource Content Server SCF1 or SCF2. In this way unnecessary network loading can be avoided and the number of Slave Resource Content Servers SCF1 and SCF2 can be reduced.

In the case of the second provider, the update rate can be set to 1 hour or ‘immediately’, i.e. the recorded message is not cached in the Resource Voice Server VF. More resources must be scheduled here. However, the usage of these resources can be billed, as all the changes are logged and tickets created.

For the system messages, the Resource Voice Server VF provides information about changes directly, as these changes do not occur very frequently and the introduction of new features by the network operator is planned long in advance.

1-25. (canceled)

26. An arrangement for a service provider triggerable provision of components for an information output or interactive dialog that is generated by an information output system or an interactive system, comprising:
a supply device accessible by the service providers for changed or new components of information outputs or interactive dialogs; and
at least one provision device that changed or new components of information outputs or interactive dialogs are transmitted by the supply device.

27. The arrangement according to claim 26, wherein the supply device comprises a storage area for components assigned to the service providers and a storage area for components assigned to the operator of the information output system or interactive system and the service providers have no access to components assigned to the operator of the information output system or interactive system.

28. The arrangement according to claim 27, wherein the service providers are authenticated and, on the supply device, only have access to components or storage areas assigned to the relevant authorized service provider.

29. The arrangement according to claim 26, wherein a configuration system is provided for generating and changing components that is assigned to a service provider and from which new or changed components are transmitted to the supply device.

30. The arrangement according to claim 26, wherein a firewall is disposed between the supply device and the configuration systems and is assigned to the service providers or a computer platform used by a service provider to access the supply device.

31. The arrangement according to claim 26, wherein an access authorization is created for the transmission of components by service providers to the supply device.

32. The arrangement according to claim 26, wherein a configuration system is provided for generating and changing components and is assigned to the operator of the arrangement and from which new or changed components are transmitted to the supply device.

33. The arrangement according to claim 26, wherein a charging server is provided to which charging information is transmitted by the supply device.

34. The arrangement according to claim 26, wherein at least one information output device is provided and associated with the information output system or interactive system and accesses at least one provision device for information outputs or interactive dialogs.

35. The arrangement according to claim 26, wherein the supply device is implemented on a hardware platform separate from the provision devices.

36. The arrangement according to claim 26, wherein a plurality of provision devices of the information output system or interactive systems to which components are transmitted by the supply device are provided.

37. The arrangement according to claim 26, wherein the supply device is implemented together with a provision device on a common hardware platform.

38. The arrangement according to claim 26, wherein the supply device is duplicated.

39. A method for providing components for newly generated or changed information outputs or interactive dialogs by an arrangement, comprising;
providing a supply device;
providing at least one provision device; and
transmitting a new or changed component of an information output or interactive dialog to the supply device that is automatically transmitted by the supply device to at least one provision device of the arrangement.

40. The method according to claim 39, wherein information in the supply device is specifiable by a service provider thereby controlling the time of activation of a new or changed component for a service.

41. The method according to claim 39, wherein a new or changed component is transmitted to the supply device by a configuration system assigned to a service provider.

42. The method according to claim 39, wherein authentication is necessary for transmitting components to the supply device from a configuration system assigned to the service provider or for accessing components assigned to a service provider in the supply device.

43. The method according to claim 39, wherein components changed or newly generated by a service provider are stored in a storage area of the supply device assigned to the service provider.

44. The method according to claim 39, wherein a new or changed component is transmitted to the supply device by a configuration system assigned to the operator of the storage system.

45. The method according to claim 39, wherein the modification or creation of a component by a service provider is charged.

46. The method according to claim 45, wherein charging information is transmitted by the supply device to a charging server.

47. The method according to claim 46, wherein an information output device accesses a provision device in the course of an information output or interactive dialog for the purpose of component transmission.

48. The method according to claim 47, wherein the information output device composes an information output or an output forming part of an interactive dialog from or by means of components.

49. The method according to claim 39, wherein a plurality of components are constituted by coded or to be encoded elements of an information output or formation rules for information outputs or interactive dialogs.

50. The method according to claim 39, wherein the information output relates to an output of voice information, video information or audio information.
